(19) United States
(12) Patent Application Publication
(10) Pub. No.: US 2002/0129845 A1
(43) Pub. Date: Sep. 19, 2002

(54) Crutch pad cover

(76) Inventor: Susan Silverstein, New York, NY (US)

Correspondence Address: WILLIAM COLLARD, COLLARD & ROE, P.C., 1077 NORTHERN BOULEVARD, ROSLYN, NY, 11576, US

(21) Appl. No.: 09/805,258

(22) Filed: Mar. 13, 2001

(51) Int. Cl. A45B 3/00; A45B 5/00; A41D 5/00; A61H 3/00

(52) U.S. Cl. 135/71; 135/72; 135/66; 135/67; 135/68; 135/73; 2/66; 446/72; 446/369

(57) ABSTRACT

A decorative crutch pad cover and a kit for decorating a crutch. This decorative crutch pad cover is designed to fit over a crutch pad situated in a top region of a crutch. There may also be a matching crutch hand pad cover that is designed to cover a crutch hand pad. Both the crutch pad cover and the crutch hand pad cover have a fastener for fastening the crutch pad cover and the crutch hand pad cover over pads on the crutch. There is also a method for decorating a crutch using a crutch pad cover and a crutch pad hand cover. The crutch pad cover is wrapped around a crutch pad and fastened to that crutch pad while the crutch pad hand cover is wrapped around the crutch hand pad and fastened to that crutch hand pad.

### BACKGROUND OF THE INVENTION

1. Field of the Invention

The invention relates to a cover for crutch pads. More particularly the invention relates to a removable decorative cover for crutch pads.

2. Description of the Prior Art

Decorative covers for crutch pads are known in the art. For example, U.S. Pat. No. 4,027,687 to McGowan discloses a protective and/or decorative cover for a crutch. This protective and/or decorative cover comprises a plurality of interconnected members, including at least one support member and one or more leg members. The cover comprises a flexible material which includes one or more non-split primary tube portions with open ends to slidably enclose one or more of these leg members. There is also one or more elongated secondary tube portions which are split longitudinally for wrap-around enclosing engagement with other leg or support members. The tube portion has opposed edge surfaces which are releaseable, and an interengaging fastener means, such as velcro.

U.S. Pat. No. 5,078,640 to Berman discloses a plaything, such as a stuffed animal that is usable as a crutch pad that includes an outer case and an inner compressible filler. The outer case includes walls that define a pocket for receiving the upper cross piece of a crutch. The crutch can fit inside this plaything.

U.S. Pat. No. 5,101,846 to Greatwood discloses a covered crutch pad. In this case, the crutch pad has an outer envelope form from flocked material, such as fake fur. The crutch pad is designed to add padding, not only to the top, but also to the sides of the crutch. This crutch pad is attached in a manner to reduce shifting and sliding in the crutch pad. It is attached so that it is easily removable from the crutch, yet when attached, it functions to prevent movement relative to the crutch and thus allows more comfort, longer use, and better control of the crutch.

U.S. Pat. No. 5,645,095 to Ramonowski discloses a waterproof, stain proof and nonporous crutch pad cover formed out of material having a low coefficient of friction. The crutch pad cover includes an elongated pad along a portion of its length. Disposed on this crutch pad, is a hook-and-loop type material such as velcro, which is used to fasten the pad to the crutch.

U.S. Pat. No. 4,711,261 to Rosenberg discloses a cushion or cover for a crutch, wherein this cover has a pair of transversely spaced columns. In this case, the cushion contains a cover portion 50 and a series of hook-and-loop fasteners 52 and 54, such as velcro. In this case, the cover contains a cushioning fabric that is washable, self-detaching and perspiration absorbent.

U.S. Pat. No. 5,865,180 to Sigfrid discloses a shoulder, arm or hand cushion that includes a plush fabric piece having dual overlapping opposing pockets formed therein for resilient pad. In this case, its a viscoelastic gel pad.

U.S. Pat. No. 5,139,040 to Kelly discloses a crutch which is assembled in a plurality of manageable components. This crutch has a removable crutch pad.

U.S. Pat. No. 5,560,382 to Wagner discloses an air cushion crutch pad that generally includes a sealed hollow chamber having an air cushion disposed therein, and a cavity which provides a means for removably mounting the crutch pad to a upper cross piece of a crutch. There are a series of opposing sidewalls of the sealed hollow chamber that include rounded upper portions and straight vertical lower portions.

U.S. Pat. No. D380,893 to Sigsworth discloses a decorative crutch pad that looks like a hat.

Finally, U.S. Pat. No. 5,331,988 to Harmon comprises a walking cane that contains an additional removable decorative cover. In this case, there is a decorative cover that has a slit for covering a cane.

The present invention is an improvement over the prior art because the present invention is essentially only a removable decorative cover that is not permanently attached to any of the padding on the crutch. In addition, this invention can also be in the form of a kit wherein there is also a removable cover for an underarm crutch pad and a removable cover for a hand crutch pad.

### SUMMARY OF THE INVENTION

The invention relates to a kit that comprises removable crutch pad covers that are designed to be semi-permanently fixed to a crutch pad. Essentially, this kit includes a decorative underarm crutch pad cover that is designed to slip over a crutch pad to cover that crutch pad. In addition, this kit also includes a decorative hand pad cover that is designed to cover the hand pad.

The underarm crutch pad cover is designed similar to a fitted sheet. Essentially this design includes a sheet portion an elastic end portion and a fastening portion. The sheet portion is designed to be decorative and can have many different colors or patterns. For example, this sheet portion can be made from black satin cloth to decorate the crutch for formal evening wear. In addition, the sheet portion could be made from a paisley pattern, or any other type pattern to match a user's tie or scarf. The elastic end portion provides for a snug fit over the underarm pad. While the fastening portion keeps the underarm crutch pad cover on the underarm crutch pad.

To put this cover on an underarm crutch pad, the cover is pulled open so that the fastener unfastens creating an open crutch pad cover. Next, this crutch pad cover is fitted over the crutch pad. The elastic portion of the crutch pad cover creates a snug fit for the crutch pad cover on the crutch pad. Next, the crutch pad cover is re fastened on the crutch pad so that it remains on the crutch pad.

The cover for the crutch hand pad is designed as a simple strip of cloth or fabric having a matching pattern and texture as with the underarm crutch pad cover. This crutch hand pad cover also has a fastener disposed within a fastening region. The fastener can be either snaps, a hook and loop fastener, buttons or any other type fastener to attach two ends of fabric. To attach the crutch pad cover, the fastener is unfastened and then the cover is wrapped around the crutch hand pad when it is on the crutch. Next, the fastener is re-fastened so that it secures the crutch hand pad cover to the crutch hand pad.

With this design, it is possible for a user to decorate his or her crutches with decorative covers. Because these decorative covers are easily removable from or placed over the crutch pads, it is possible for users to easily change the crutch pad covers as they can be easily removed from these crutch pads.

### BRIEF DESCRIPTION OF THE DRAWINGS

Other objects and features of the present invention will become apparent from the following detailed description considered in connection with the accompanying drawings which disclose several embodiments of the present invention. It should be understood, however, that the drawings are designed for the purpose of illustration only and not as a definition of the limits of the invention.

In the drawings wherein similar reference characters denote similar elements throughout the several views:

FIG. 1 is a side view of a crutch patd cover and a crutch pad hand cover;

FIG. 2A is a side view of the crutch pad cover being placed on a crutch pad;

FIG. 2B is a side view of a crutch;

FIG. 3 is a side view of a crutch pad cover; and

FIG. 4 is a perspective view of the crutch hand pad cover.

### DETAILED DESCRIPTION OF THE PREFERRED EMBODIMENT

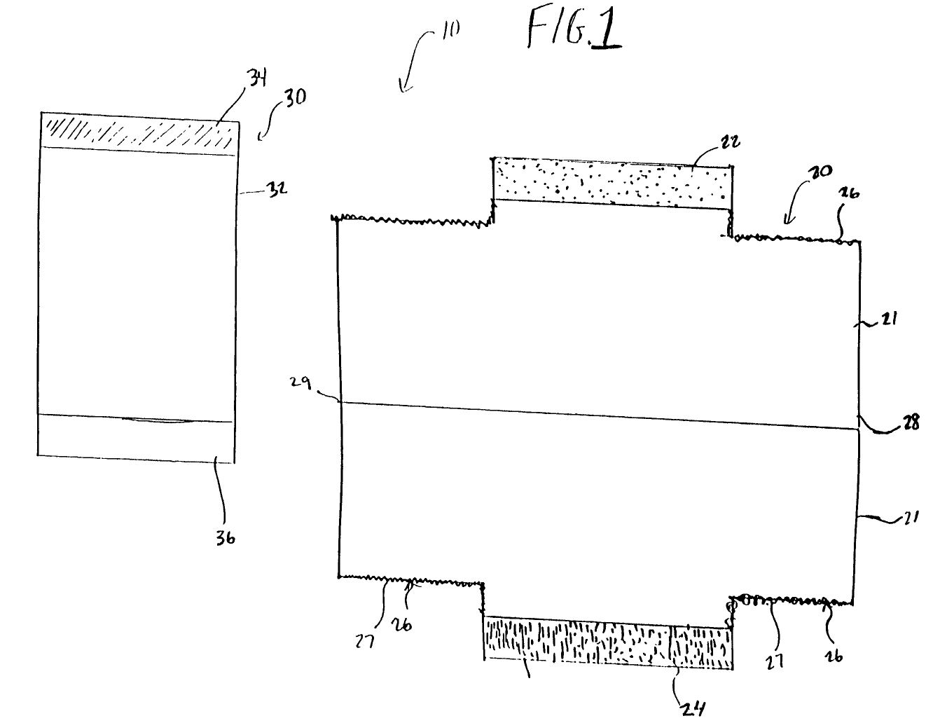

FIG. 1 refers to a perspective view of a kit 10 which contains an underarm crutch pad cover 20 and crutch pad hand cover 30. Underarm crutch pad cover 20 covers an underarm crutch pad (not shown) and a hand crutch pad cover covers a hand crutch pad (not shown).

Underarm crutch pad cover 20 contains a sheet or fabric portion 21, a first fastening strip 22, and an oppositely disposed second fastening strip 24. First fastening strip 22 and second fastening strip 24 can be in the form of a hook and loop fastening strips, a series of oppositely disposed snaps on these fastening strips, buttons and oppositely disposed eyelets, or laces to secure fastening strip 22 to fastening strip 24.

Sheet or fabric portion 21 can be made of a decorative fabric such as black satin for evening wear, paisley for semi-formal or dinner wear, or have informal patterns and motifs such as sports teams, an action sequence, scenery etc. This decorative fabric can be coated with a chemical or any other type coating to protect it from wear and from getting dirty.

Elastic portion 26 includes at least one elastic band 27 that is designed to draw cover 20 in to keep it snug on the crutch pad. Elastic portion 26 is designed to only extend out from fastening strips 22 and 24 to a side edge 28. Elastic portion 26 does not extend onto side edge 28 because it would result in side edge 28 bunching up around the underarm crutch pad and keeping underarm crutch pad cover 20 from adequately securing to the underarm crutch pad. Instead, with this design, side edge 28 is pulled in by elastic band 27 so that cover 20 covers both a front and back region of the crutch pad cover. Side edges 28 on cover 20 close over the crutch pad when fastening strips 22 and 24 are fastened into each other around a crutch pad. This result occurs because fastening strips 22 and 24 secure cover 20 in a central region, wherein elastic portion 26 then pulls side edges 28 in towards this central region so that side edges now curl over the crutch pad.

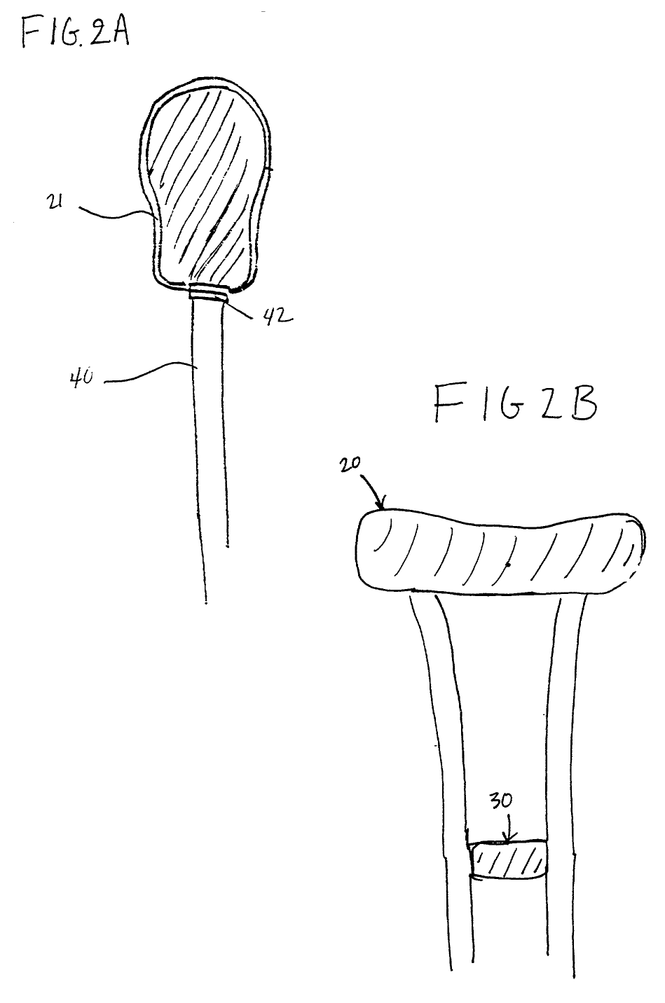

Crutch pad hand cover 30 comprises a sheet 32 and a fastener, or a series of fastening strips 34 and 36 disposed on both ends of sheet 32. Crutch pad hand cover 30 is designed to cover a crutch hand pad disposed in a mid region of a crutch (See FIG. 2B).

FIG. 2A shows crutch pad cover 20 being placed over a crutch pad on crutch 40. Crutch 40 also contains arms that extend around fastening strips 22 and 24 (not shown) so that fastening strips 22 and 24 are disposed inside of arms 42. For example, as shown in FIG. 2B crutch pad cover 20 and crutch pad hand cover 30 are disposed over a crutch pad and a crutch hand pad on crutch 40.

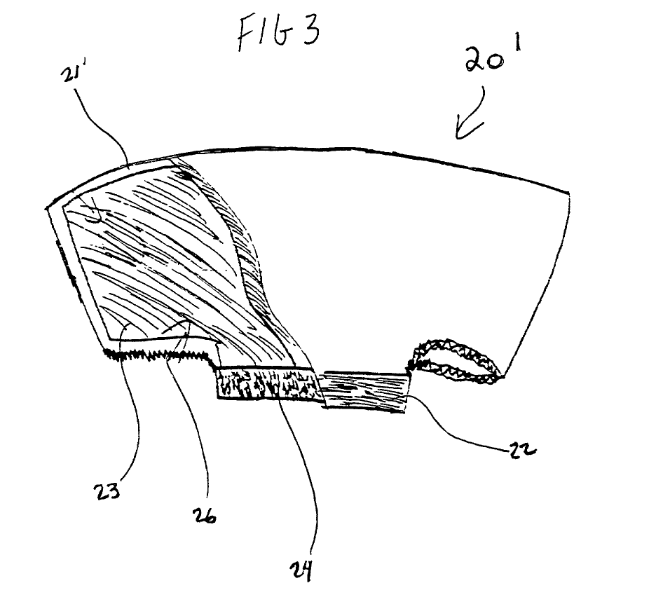

FIG. 3 shows a second embodiment 20′ of a crutch pad cover 20. Second embodiment 20′ includes a sheet 21′ fastening strips 22 and 24, and an inner liner or padding 23. Inner liner or padding 23 is designed to form an additional pad for crutch pad cover 20.

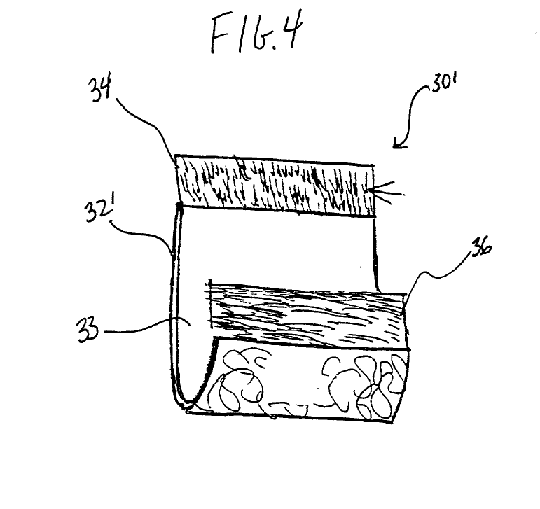

FIG. 4 shows a second embodiment 30′ of hand pad cover 30. Second embodiment hand pad cover 30′ contains fastening strips 34 and 36. Hand pad cover 30′ also contains an additional liner 33 that fits inside of sheet 32′. Additional liner 33 creates additional padding for the user on top of a crutch hand pad (not shown).

A crutch can be decorated using both the crutch pad and the crutch hand pad. For example, the crutch pad is decorated by wrapping sheet 21 around a crutch pad and then attaching fastening strips 22 and 24 together. At this point elastic member pulls on sheet 21 to force sheet 21 to wrap around the crutch pad.

Crutch hand pad 30 is also attached by wrapping sheet 32 around a crutch hand pad and then attaching fastening strips 34 and 36 together. Sheets 32 and 21 preferably match in patterns and style so that when the combination of crutch hand pad 30 and crutch pad 20 are applied to a crutch, these covers 20 and 30 decorate this crutch.

Accordingly, while several embodiments of the present invention have been shown and described, it is to be understood that many changes and modifications may be made thereunto without departing from the spirit and scope of the invention as defined in the appended claims.

What is claimed is:

1. A cover device for a crutch comprising:
a sheet;
at least one elastic member disposed in said sheet;
at least one first fastener disposed on said sheet; and
at least one second fastener disposed on said sheet for fastening with said first fastener when said sheet wraps around a crutch pad on a crutch wherein said at least one elastic member pulls on said sheet to wrap said sheet around said crutch pad.

2. The crutch pad cover as in claim 1, wherein said elastic member pulls said sheet towards said at least one first fastener and said at least one second fastener when said at least one first fastener is fastened to said at least one second fastener.

3. The crutch pad cover as in claim 1, wherein said sheet further comprises at least one side edge wherein said at least one elastic member extends from said at least one first fastener to said at least one side edge.

4. The crutch pad cover as in claim 1, wherein said sheet further comprises at least one additional elastic member, wherein said at least one additional elastic member extends from said at least one second fastener to said side edge.

5. The crutch pad cover as in claim 1, further comprising a folding line or crease disposed on said sheet, said folding line to guide a user in folding said sheet over a crutch pad.

6. A crutch pad cover kit comprising:
a crutch pad cover comprising:
at least one sheet;
at least one fastener connected to said sheet said fastener for fastening said sheet cover over a crutch pad; and
at least one elastic member for pulling said sheet over said crutch pad; and
a crutch pad hand cover comprising:
at least one sheet; and
at least one fastener connected to said sheet, said fastener for fastening said sheet over said crutch pad, wherein said sheet from said crutch pad cover and said sheet from said crutch hand pad cover have matching patterns.

7. A method for decorating a crutch comprising the following steps:
providing a decorative sheet;
providing at least one fastener disposed on said sheet;
providing at least one elastic member disposed on said sheet;
wrapping said sheet around a crutch pad; and
fastening said sheet to said crutch pad so that said sheet substantially covers said crutch pad to decorate the crutch.

8. The method as in claim 7, further comprising the steps of:
providing a sheet that matches said decorative sheet;
providing a fastener disposed on said matching sheet;
wrapping said matching sheet to an additional pad on the crutch; and
fastening said matching sheet to said additional pad on the crutch.
